(19) United States
(12) Patent Application Publication
(10) Pub. No.: US 2009/0319944 A1
(43) Pub. Date: Dec. 24, 2009

(54) NAVIGATION DISPLAY INCLUDING MULTI-CONTROL WINDOW

(75) Inventors: Kantha Chikkegowda, Bangalore (IN); Kalimulla Khan, Bangalore (IN)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: Honeywell International Inc., Morristown, NJ (US)

(21) Appl. No.: 12/138,043

(22) Filed: Jun. 12, 2008

(51) Int. Cl. G06F 3/048

(52) U.S. Cl. 715/804

(57) ABSTRACT

A display system, including a main window and a multi-control window, for displaying graphical data in a navigation display. The display system further includes one or more sensors for obtaining data regarding at least one of traffic targets, waypoints and craft trajectories. One or more processors are configured to receive the data from the one or more sensors and provide input to the display screen. The display screen is configured to display a portion of the data in the main window as a primary display view and another portion of the data in the multi-control window as a secondary display view. The primary display view and the secondary display view are interchangeable to display the data in different view modes.

### TECHNICAL FIELD

The present invention generally relates graphical displays, and more particularly relates to graphical navigation displays used when operating an aircraft.

### BACKGROUND

Many aircraft have a number of graphical displays, including a navigation display system (NDS) configured to display information relevant to an aircraft's current position and trajectory. During operation of an aircraft, it is beneficial for the operator to quickly change views, such as from a current aircraft plan view to a trajectory path view, to determine the current status of the aircraft as well as what traffic targets, such as physical terrain or other aircraft, are approaching and determine how best to avoid the traffic targets. Current technology provides the operator with much of the information needed to complete this task. For example, real-time sensors can indicate on a display current location, speed and direction of the aircraft as well as where various waypoints and traffic targets are located. The ability of these sensors to accurately detect relevant data, such as target location, speed, direction, etc., is continuously being improved. However, current displays are limiting in the ability of the operator to quickly ascertain and understand the data being delivered from the sensors.

On a typical flight there are many instances where the operator may desire to change the information viewed in the navigation display (ND), including changes in view range (10 nm, 20 nm, 40 nm, 80 nm, etc.) and view mode (approach (APP), visual omni-range (VOR), map view (MAP), or plan view (PLAN)). These changes enable the operator to better ascertain the current or relative position of the aircraft, its active trajectory, and its downpath trajectory. While any flight plan change may be viewed in a current flight plan view, the operator may also wish to see the changes in a downpath trajectory view. Often these changes in view are done many times during the course of a flight and the operator would benefit from viewing multiple views simultaneously, such as the downpath trajectory information in addition to current flight plan views. Often, in addition to the primary flight plan, a secondary flight plan is in place as a backup. It would be beneficial for the operator to view the secondary flight plan, while simultaneously viewing the primary flight plan. Unfortunately, with the current NDS the pilot is unable to see multiple views simultaneously. More specifically, in an existing NDS, the operator is not able to simultaneously view the trajectory information for different ranges (10 nm, 20 nm, 40 nm, 80 nm, etc.) or different modes (plan map, etc.) while viewing the current flight plan view. In order to do so, the operator often must continuously switch a single view display between the two views.

This lack of a graphical representation on an aircraft's NDS to enable multiple views, including the aircraft's primary flight plan, the active trajectory, the downpath trajectory, the secondary flight plans, etc. limits the operator's ability to make quick determinations with respect to the current position of the aircraft.

Therefore, there is a need for a display that provides multiple graphical representations relevant to an aircraft's flight in a single view. Furthermore, other desirable features and characteristics of the inventive subject matter will become apparent from the subsequent detailed description of the inventive subject matter and the appended claims, taken in conjunction with the accompanying drawings and this background of the inventive subject matter.

### BRIEF SUMMARY

The present invention provides a navigation display including a multi-control window. In one embodiment and by way of example only, the display comprises a display screen for graphical display of data, one or more sensors for obtaining the data regarding at least one of traffic targets, waypoints and at least one craft trajectory; and one or more processors for receiving the data from the one or more sensors and for providing input to the display screen. The display screen includes a main window and a multi-control window. The display screen displays the data in the main window and the multi-control window as a primary display view and a secondary display view.

In another particular embodiment, and by way of example only, there is provided a display screen for graphical display of data, one or more sensors for obtaining the data regarding at least one of traffic targets, waypoints and craft trajectories; and one or more processors configured to receive the data from the one or more sensors, compute the data received and provide input to the display screen. The display screen includes a main window and a multi-control window. The display screen displays a portion of the data in the main window as a primary display view and another portion of the data in the multi-control window as a secondary display view.

In yet another particular embodiment, and by way of example only, there is provided a computer readable medium having computer-executable instructions for performing a method. The method comprising the steps of receiving at least one of traffic target, waypoint and craft data from traffic sensors; determining informational data of a craft based on the received traffic target, waypoint and the craft data identified by the traffic sensors; processing the informational data based on the traffic target, waypoint and the craft data identified by the traffic sensors; providing input to a graphical display configured to display the informational data; and sending instructions to the graphical display to display a primary display view of at least a portion of the informational data in a main window and a secondary display view at least another portion of the informational data in a multi-control window.

Other independent features and advantages of the preferred display system will become apparent from the following detailed description, taken in conjunction with the accompanying drawings which illustrate, by way of example, the principles of the invention.

### BRIEF DESCRIPTION OF THE DRAWINGS

The present invention will hereinafter be described in conjunction with the following drawing figures, wherein like numerals denote like elements, and

FIG. 1 is an image of a graphical display according to an embodiment; and

FIG. 2 is a block diagram of a graphical display system according to an embodiment.

### DETAILED DESCRIPTION

The following detailed description is merely exemplary in nature and is not intended to limit the invention or the application and uses of the invention. Furthermore, there is no intention to be bound by any theory presented in the preceding background or the following detailed description.

The embodiments disclosed herein are described in sufficient detail to enable those skilled in the art to practice the invention, and it is to be understood that other embodiments may be utilized and that logical, mechanical and electrical changes may be made without departing from the scope of the present invention. Furthermore, it will be understood by one of skill in the art that although the specific embodiments illustrated below are directed at aircraft for purposes of explanation, the method and apparatus may be used in various embodiments employing various types of crafts configured to use displays, such as submarines, space craft, lunar landing craft, and unmanned air vehicles (UAV), etc. The following detailed description is, therefore, not to be taken in a limiting sense.

An embodiment is described herein in terms of a functional block diagram. It should be appreciated that such functional blocks may be realized in many different forms of hardware, firmware, and or software components configured to perform the various functions. For example, embodiments of the present invention may employ various integrated circuit components, e.g., memory elements, digital signal processing elements, look-up tables, and the like, which may carry out a variety of functions under the control of one or more microprocessors or other control devices. Such general techniques are known to those skilled in the art and are not described in detail herein. Moreover, it should be understood that the exemplary process illustrated may include additional or fewer steps or may be performed in the context of a larger processing scheme.

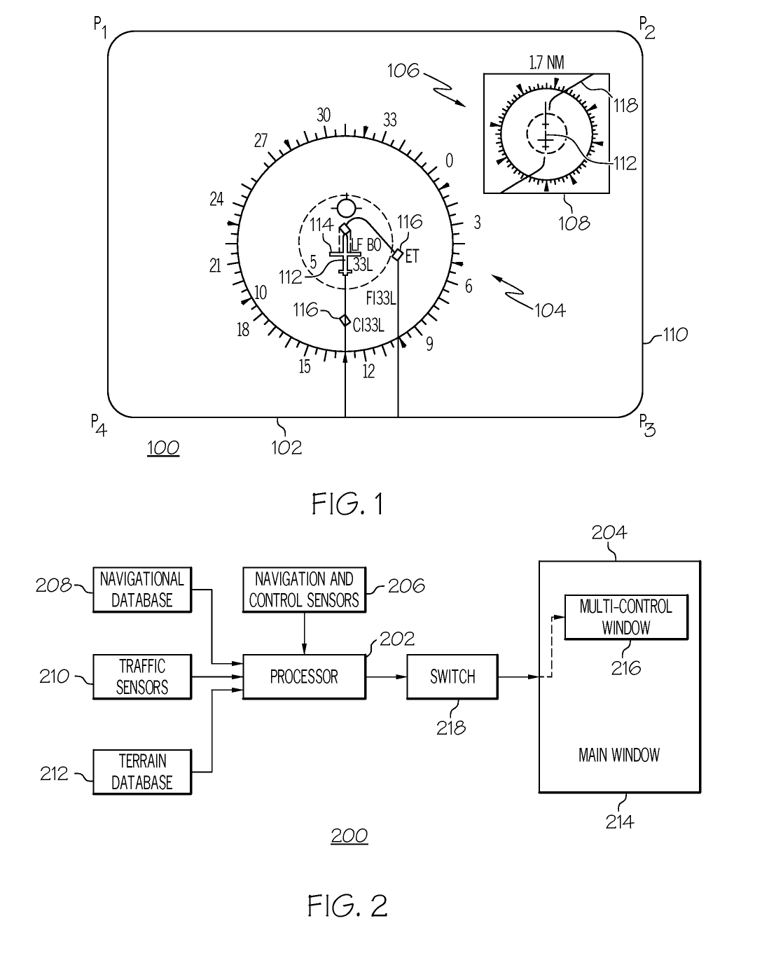

Referring now to the accompanying figures, FIG. 1 illustrates an image of a graphical display 100 according to one embodiment. The graphical display 100 includes main window 102 for viewing a primary display view 104 and multi-control window 106 for viewing a secondary display view 108. In a preferred embodiment, the multi-control window 106 is configured having smaller dimensions than the main window 102, and more particularly, configured to appear as an inset within the main window 102. The references P1, P2, P3 and P4 represent coordinates that define an edit area 110, or computed display area, of the graphical display 100. In the illustrated embodiment, the primary display view 104 is displayed in plan mode and includes an aircraft representation 112 and a current flight plan 114 for the aircraft indicated by the aircraft representation 112. Further illustrated in the primary display view 104 is a plurality of waypoints 116.

The secondary display view 108 of the graphical display 100 is viewed within the multi-control window 106 on the graphical display 100. In this particular embodiment, the secondary display view 108 is displayed in map mode and depicts a downpath trajectory 118 of the aircraft indicated by the aircraft representation 112. More specifically, in this embodiment the secondary display view 108 depicts a portion of the aircraft downpath trajectory 118 to be flown in a referenced amount of time from the current time in light of any changes that may have been made to the current flight plan 114 viewable in the primary display view 104. As an example, if the operator chooses to see a 20 knot range in the primary display view 104, then the multi-control window 106 can display as the secondary display view 108, 50 knot range trajectory data. The multi-control window 106 may be made more interactive by providing outline characteristics, so that the operator can scroll or navigate to a point of interest from the current position to a destination, and the same may be optionally shown in a larger view on the main window 102 as the primary display view 104.

During operation of an aircraft, the multi-control window 106 may be controlled by a switch that is operable by the operator dependent upon a chosen view. In one embodiment, the operator chooses the view to be displayed in the main window 102 as the primary display view 104 and the multi-control window 106 will automatically display an alternate view as the secondary display view 108. In another embodiment, the operator chooses the view to be displayed in the main window 102 as the primary display view 104 and also manually selects the secondary display view 108 to be displayed in the multi-control window 106. In yet another embodiment, the main window 102, and more particularly the primary display view 104 is static, thereby enabling the operator to continually view the active scenario and the multi-control window 106 is utilized to display dynamic operations in the secondary display view 108. This enables the operator to change the down path trajectory while still monitoring the active trajectory path viewable in the main window 102.

The embodiment described in FIG. 1 provides the operator with useful information by allowing the operator to view multiple views depicting aircraft information. The use of a graphical display including multiple display views enables the operator to gather pertinent information quickly and easily. As previously indicated, in some embodiments, the operator can manually switch between the different types of views and items being displayed in the multiple windows as described above. In other embodiment, the views are automatically displayed dependent on programmed parameters. Additionally, in some embodiments, color may be used to indicate associated aircraft and aircraft trajectories.

FIG. 2 is block diagram of a display system according to one embodiment of the present invention. In FIG. 2, an exemplary multi-view graphical display system 200 includes one or more processors 202 configured to provide information to a display element or monitor 204. One or more data sources are coupled to the one or more processors 202. These data sources include, but are not limited to, navigation and control sensors 206, a navigational database 208, traffic sensors 210 and a terrain database 212. In some embodiments, one or more of these data sources are omitted. The databases and sensors are typically located onboard an aircraft but it is not required that they be so located. For example, in some embodiments, the databases are located in a central flight tower or mission control center and the sensors are located on a surveillance craft or in a surveillance tower which relays traffic data to the aircraft. Data in these databases is stored on any type of suitable medium such as floppy disks, conventional hard disks, CD-ROM, flash ROM, nonvolatile ROM, RAM, or other suitable medium.

The one or more processors 202 include or interface with hardware components that support the multi-view graphical display system 200. By way of example and not by way of limitation, these hardware components include one or more microprocessors, memories, storage devices, interface cards, and other standard components known in the art. Additionally, the one or more processors 202 includes or functions with software programs, firmware or computer readable instructions for carrying out various methods, process tasks, calculations, control functions, and the generation of display signals, time notations, and other data used in the operation of the multi-view display system. These instructions are typically stored on any appropriate medium used for storage of computer readable instructions such as floppy disks, conventional hard disks, CD-ROM, flash ROM, nonvolatile ROM, RAM, and other like medium.

The display element 204 includes any display element suitable for displaying the various symbols and information for the operation of embodiments of the present invention. There are many known monitors that are suitable for this task, such as various CRT and flat-panel display systems. The display element 204 is preferably implemented on a panel mounted display, a heads-up display (HUD) projection, flexible organic LED (OLED) or any other existing or later developed display technology. The display element 204 includes a main window 214 for the display of a primary display view, similar to the primary display view 104 described with respect to FIG. 1, and a multi-control window 216, for the display of a secondary display view, similar to the secondary display view 108 described with respect to FIG. 1.

The one or more processors 202 generate data for display on the display element 204 based on positional and flight plan data. In some embodiments, the one or more processors 202 is configured to receive and process navigation and positional data (e.g. position, speed, direction) regarding current aircraft location from the navigation and control sensors 206. In other embodiments, the one or more processors 202 are configured to receive navigation and positional data from the navigational database 208. The navigational database 208 is configured to store data concerning one or more flight trajectories. In one embodiment, utilizing the navigational database 208, positional data is used to search for and display traffic targets and waypoints for different locations along active and downpath flight trajectories. In yet other embodiments, the one or more processors 202 are configured to receive data from the navigation and control sensors 206 and from the navigational database 208.

Based on the positional data, the one or more processors 202 may obtain terrain data from terrain database 212 and the traffic data from traffic sensors 210. Traffic sensors 210 include any number of receivers, infrared lasers, millimeter wave cameras or other sensor elements for obtaining traffic data regarding traffic targets. In some embodiments, traffic data includes data about a target's location, speed, size, and trajectory. In other embodiments, traffic data also includes data about other nearby aircraft, including type, flightplan, airline, class, and avionic equipage. Various known equipment is suitable for obtaining some or all of this data including Automatic Dependent Surveillance Broadcast (ADS-B) equipment and Traffic alert and Collision Avoidance Systems (TCAS).

The one or more processors 202 analyzes the data received from traffic sensors 210 and determines if the traffic targets, waypoints, etc. are located within the field of view, or edit area of the multi-view graphical display element 200. In some embodiments, the traffic targets and waypoints that are not within the field of view are not displayed. In other embodiments, the traffic targets and waypoints that are not within the field of view may be caged to the side of the display element 204. In some embodiments, the one or more processors 202 is configured to filter data such that data is not provided to the display element 204 concerning traffic targets, waypoints and craft trajectories which do not pose a threat to a trajectory of a reference craft.

The multi-view graphical display element 200 is configured to display in the main window 214 the primary display view and in the multi-control window 216 the secondary display view; the view being displayed being controlled by a switch 218. The switch 218 may be configured for automatic operation, manual operation, or automatic operation with manual override operation. This multi-view graphical display system 200 provides several advantages as discussed above with respect to FIG. 1.

While at least one exemplary embodiment has been presented in the foregoing detailed description of the invention, it should be appreciated that a vast number of variations exist. For example, although the specific embodiments illustrated are directed at aircraft, the method and apparatus may be used in various embodiments employing various types of crafts, such as submarines, space craft, lunar landing craft, and unmanned aerial vehicles (UAVs), etc. For this reason, it is intended that the term “craft” refer to these various embodiments. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A display system comprising:
a display screen for graphical display of data, the display screen including a main window and a multi-control window;
one or more sensors for obtaining the data regarding at least one of traffic targets, waypoints and at least one craft trajectory; and
one or more processors for receiving the data from the one or more sensors and for providing input to the display screen,
the display screen displaying the data in the main window and the multi-control window as a primary display view and a secondary display view.

2. The display system of claim 1, further including a switch for controlling a mode of each of the primary display view and the secondary display view displayed within the multi-control window and the main window.

3. The display system of claim 1, wherein the primary display view and the secondary display view are manually interchangeable between the multi-control window and the main window by a display system operator.

4. The display system of claim 1, wherein the primary display view and the secondary display view are automatically interchangeable between the multi-control window and the main window by the one or more processors.

5. The display system of claim 1, wherein the multi-control window is smaller than the main window.

6. The display system of claim 5, wherein the multi-control window is configured as an inset within the main window.

7. The display system of claim 1, wherein the one or more processors is configured to filter the data such that the data is not provided to the display screen concerning traffic targets, waypoints and craft trajectories which do not pose a threat to a trajectory of a reference craft.

8. The display system of claim 1, wherein the display system is a flight deck display system on board an aircraft.

9. The display system of claim 1, wherein the display system is a Heads-Up Display (HUD).

10. A display system comprising:
a display screen for graphical display of data, the display screen displaying a main window and a multi-control window;
one or more sensors for obtaining the data regarding at least one of traffic targets, waypoints and craft trajectories; and
one or more processors configured to receive the data from the one or more sensors, compute the data received and provide input to the display screen,
the display screen displaying a portion of the data in the main window as a primary display view and another portion of the data in the multi-control window as a secondary display view.

11. The display system of claim 10, wherein the multi-control window includes a plurality of outline characteristics enabling navigation to a point of interest being displayed in the secondary display view.

12. The display system of claim 10, wherein the one or more processors is configured to provide the data to the display screen in at least one of a plurality of view modes, including a MAP view mode, a PLAN view mode, a VOR view mode, and an APP view mode.

13. The display system of claim 12, further including a switch for controlling the plurality of view modes displayed within each of the multi-control window and the main window.

14. The display system of claim 10, wherein the multi-control window is configured as an inset within the main window.

15. The display system of claim 10, wherein the primary display view and the secondary display view are manually interchangeable by a display system operator.

16. The display system of claim 10, wherein the primary display view and the secondary display view are automatically interchangeable by the one or more processors.

17. The display system of claim 10, wherein the display system is a flight deck display system on board an aircraft.

18. The display system of claim 10, wherein the display system is a Heads-Up Display (HUD).

19. A computer readable medium having computer-executable instructions for performing a method comprising:
receiving at least one of traffic target, waypoint and craft data from traffic sensors;
determining informational data of a craft based on the received traffic target, waypoint and the craft data identified by the traffic sensors;
processing the informational data based on the traffic target, waypoint and the craft data identified by the traffic sensors;
providing input to a graphical display configured to display the informational data; and
sending instructions to the graphical display to display a primary display view of at least a portion of the informational data in a main window and a secondary display view at least another portion of the informational data in a multi-control window.

20. A computer readable medium as claimed in claim 19, further comprising:
switching the primary display view and the secondary display view between the main window and the multi-control window.
